(19) United States
(12) Patent Application Publication
(10) Pub. No.: US 2026/0309476 A1
(43) Pub. Date: Oct. 8, 2026

(54) DEVICE AND METHOD FOR MEASURING CONVEYOR BELT ELONGATION

(71) Applicant: Laitram, L.L.C., Harahan, LA (US)

(72) Inventors: Jason Lagneaux, Jefferson, LA (US); Sven-Erik Haitjema-Burrough, Koog aan de Zaan (NL)

(21) Appl. No.: 19/481,634

(22) PCT Filed: Apr. 30, 2024
(86) PCT No.: PCT/US2024/027002

§ 371 Date: Nov. 5, 2025

Related U.S. Application Data
(60) Provisional application No. 63/467,053, filed on May 17, 2023.

(51) Int. Cl. G01B 5/30; B65G 43/02; G01B 3/04

(52) U.S. Cl. CPC G01B 5/30; B65G 43/02; G01B 3/04

(57) ABSTRACT

A device and method for measuring the elongation, or stretch, of a conveyor belt. The device comprises a base, a measurement starting mark on the base and an elongation scale on the base spaced from the measurement starting mark and indicative of a percentage of belt elongation for a first belt pitch. A first repeating, measurable feature of the conveyor belt is aligned with the measurement starting mark and the position of a second repeating, measurable feature of the conveyor belt relative to the elongation scale is measured to determine a percentage of elongation.

### RELATED APPLICATIONS

This application claims priority to U.S. Provisional Patent Application No. 63/467,053, filed May 17, 2023 and entitled “Device and Method for Measuring Conveyor Belt Elongation”, the contents of which are herein incorporated by reference.

### BACKGROUND

The invention relates generally to power-driven conveyors and more particularly to systems and methods for measuring the elongation, or stretch, of conveyor belts.

Endless conveyor belts are widely used in many industries to move, sort, carry, store or process items. Conveyor belts are generally trained around a drive, such as a sprocket, and one or more idler rollers to form a circuit or loop comprising an infeed, upper carryway, outfeed and a lower returnway. Articles are conveyed atop the conveyor belt supported along an upper carryway. The conveyor belt returns along a lower returnway.

Endless conveyor belts can be formed by a series of modules connected together, or comprise a monolithic structure with ends connected together, or be formed through other means known in the art. The monolithic structure can be flat or include positive drive features. Modular conveyor belts are constructed of rows of one or more belt modules joined end to end by hinge rods at hinge joints. The belt modules can be forms of plastic, metal, or another suitable material. When new, the belts have a nominal belt pitch, which is the distance between consecutive hinge joints or the distance between consecutive drive elements, or other consistent features. The nominal belt pitch is matched by the pitch of drive or idle sprockets that positively engage drive structure on the conveyor belt. The sprocket pitch is the distance between consecutive sprocket teeth. As the conveyor belt wears over time, it elongates, or stretches, in the direction of belt travel, and the belt pitch increases. The increase in pitch is due to cam-shafting of the hinge rods, wallowing out of the hinge eyes at the hinge joints, material stretch, for example, plastic stretch in high-temperature applications and—or due to permanent deformation of the belt material.

It is useful to be able to measure belt stretch to anticipate degraded belt performance and take remedial action, such as replacement of the belt. Stretching degrades the positive engagement of a positively driven belt with the teeth of its drive sprocket. Stretching also presages belt failures due to aging. If the stretch is great enough, say about 3%, sprocket-to-belt engagement starts to degrade, and the belt intermittently disengages from some of the sprocket teeth and rides over them. Because belt failures can be costly, a number of schemes for measuring belt stretch have been used. Many of those schemes require that special-purpose markers be added to a belt separated by a nominal distance. Detectors along the belt's travel path sense the passage of the markers and determine belt stretch from the times of passage. Conventional special-purpose markers serve no purpose other than as detectable position marks on a belt.

Other means for determining belt elongation involves physically measuring a distance between points on spaced-apart belt modules, dividing the measured distance by the number of modules between the points and comparing the resulting number with the original belt pitch. Such a method is subject to human error and limited by difficulty in counting the number of modules.

### SUMMARY

A device or ruler for measuring conveyor belt elongation comprises a base on which pre-measured markings for measuring elongation are formed. A measurement starting mark is located in a first position on the base. An elongation scale is also formed on the base, spaced from the measurement starting mark and corresponds to a particular conveyor belt pitch. The elongation scale measures the elongation of a conveyor belt of that particular conveyor belt pitch. The elongation scale can comprise a sequence of marks on the base, each corresponding to a percentage of belt elongation for the particular conveyor belt pitch.

According to one aspect, a device for measuring elongation of a conveyor belt comprises a base, a measurement starting mark on the base and an elongation scale spaced from the measurement starting mark. The elongation scale comprising a sequence of marks on the base, each mark corresponding to a percentage of belt elongation for a first belt pitch.

According to another aspect, a device for measuring elongation of a conveyor belt comprises a base, a measurement starting mark on the base, a first elongation measurement region spaced from the measurement starting mark by a first distance and a second elongation measurement region spaced from the measurement starting mark by a second distance. The first elongation measurement region corresponds to a first belt pitch and the second measurement region corresponds to a second belt pitch. The first distance is a multiple of the first belt pitch and the second distance is a multiple of the second belt pitch.

According to another aspect, a method of measuring conveyor belt elongation in a conveyor belt comprising a plurality of connected conveyor belt modules is provided. The method comprises the steps of aligning a first structural feature of a first conveyor belt module with a measurement starting mark on a base of a measuring device, aligning a second conveyor belt module with an elongation scale on the base of the measuring device; and determining a position of a first structural feature of the second conveyor belt module along the elongation scale on the measuring device.

### BRIEF DESCRIPTION OF THE DRAWINGS

FIG. 1 is a front view of a measuring device according to an embodiment;

FIG. 2 is a detailed view of the elongation scale of the measuring device of FIG. 1;

FIG. 3 shows the measuring device of FIG. 1 along a modular conveyor belt with 0% elongation;

FIG. 4 shows the measuring device of FIG. 1 along a modular conveyor belt with 3% elongation;

FIG. 5 is a detailed view of the elongation scale along the modular conveyor belt of FIG. 4;

FIG. 6 is a front view of a measuring device according to another embodiment;

FIG. 7 is a front view of a measuring device according to another embodiment;

FIG. 8 is a front view of a measuring device according to another embodiment;

FIG. 9 is a rear view of the measuring device of FIG. 8;

FIG. 10 is a front view of a measuring device including a slide to facilitate measuring, according to another embodiment.

### DETAILED DESCRIPTION

A tool for measuring belt elongation includes a measurement starting mark and an elongation scale corresponding to a particular conveyor belt pitch. The invention will be described relative to certain illustrative embodiments, but is not limited to those embodiments.

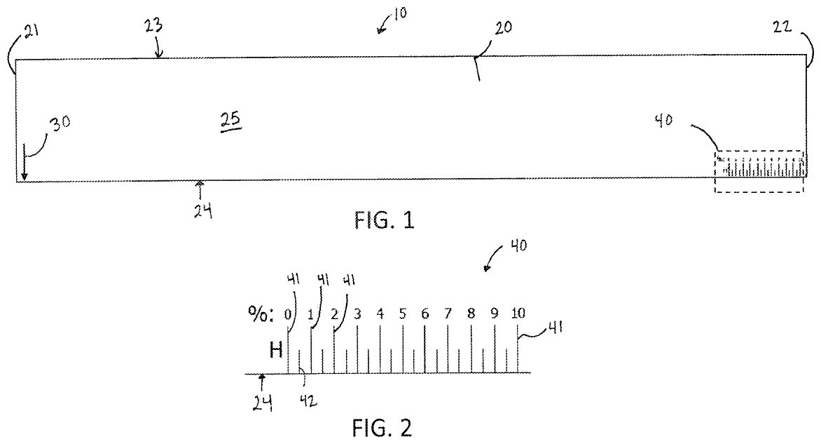

FIG. 1 is a front view of a measuring device 10 suitable for measuring elongation of a conveyor belt. The measuring device 10 can be used to determine the condition of the belt and indicate when the belt should be replaced. The illustrative measuring device comprises a base 20 with markings. The illustrative markings are black, but the invention is not so limited. The illustrative base 20 is substantially rectangular, with a first side edge 21, a second side edge 22, a top edge 23, a bottom edge 24, a first face 25 and an opposite second face (not shown). The base is substantially planar and may have any suitable thickness, but alternatively may be non-planar and have a different shape than a rectangle. The base 20 may be flexible or rigid, transparent, semi-transparent or opaque. The base 20 may be foldable, rollable and—or comprise multiple hingedly-connected components. Suitable materials include, but are not limited to stainless steel, plastic and fabric. The markings may be etched into the base, printed onto the base, painted onto the base, laser-marked onto the base, integrally formed with the base (through injection-molding or another manufacturing process), embedded within the base or otherwise associated with the base 20 through any suitable means.

A measurement starting mark 30 is formed on the first face 25 or displayable through the first face 25. The illustrative measurement starting mark 30 is inset from the first side edge 21, but the invention is not so limited. The measurement starting mark 30 comprises an arrow pointing to a point on the bottom edge 24 to show where the measurement of the belt should begin. Other suitable symbols may be used to indicate the starting point for measuring conveyor belt elongation. The measurement starting mark may be etched, printed or otherwise formed on or in the base 20.

An elongation scale 40 is spaced from the measurement starting mark 30 along the bottom edge 24. The elongation scale 40 is used to measure a percentage elongation for a selected conveyor belt pitch.

As shown in FIG. 2, the illustrative elongation scale 40 comprises a sequence of marks 41 on or in the base extending to the bottom edge 24. Each mark 41 corresponds to a percentage of belt elongation for a particular belt pitch. The illustrative elongation scale also includes half-percentage marks 42, but the invention is not so limited. The illustrative marks are lines, but could comprise other types of marks, such as dots. While the illustrative marks 41 extend to the bottom edge 24 to facilitate alignment with a feature on a conveyor belt being measured, the invention is not so limited, and the marks can be placed in any suitable location to facilitate measurement.

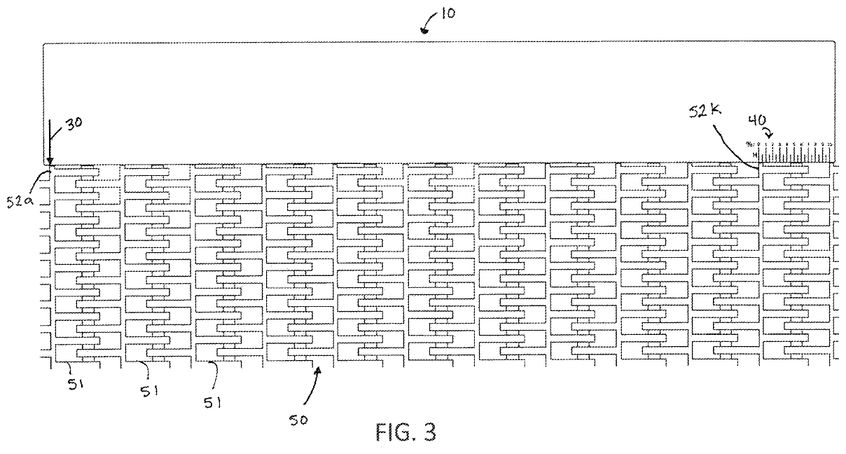

FIG. 3 shows use of the measuring device 10 to measure elongation in a modular conveyor belt 50 of a particular belt pitch. The illustrative conveyor belt 50 comprises a series of hingedly connected belt modules 51, each having interleaved hinge elements joined by a hinge rod, but the invention is not so limited. The measuring device can be used with any conveyor belt having repetitive, measurable features, such as drive bars.

To measure belt elongation, the measuring device 10 is brought adjacent to or near the conveyor belt 50 and a structural feature of a conveyor belt module 51 is aligned with the measurement starting mark 30. The illustrative structural feature is the spine 52a of a first module 51, but could comprise any measurable feature, such as a hinge rod, hinge opening, drive tooth, protrusion, recess, a non-structural marking or other feature. Then, a user determines the position of the same structural feature 52k in a subsequent module 51 that falls within the elongation scale 40. In the embodiment of FIG. 3, the conveyor belt 50 has 0% elongation, as shown, with the structural feature 52k aligning with the “0” mark in the elongation scale 40, showing no elongation of the conveyor belt. The elongation scale 40 has been pre-measured for the particular belt pitch of the conveyor belt 50, so that the distance between the measurement starting mark 30 and the “0” mark in the elongation scale 40 equals the belt pitch times a selected number of modules (in this case, 10 modules). Each mark 41 is subsequently spaced by a distance equal to 1% of the associated belt pitch. For example, for a belt pitch of 1.5 inches, the marks 41 are separated by a distance of 0.15 inches representing 1% elongation over ten modules. The elongation scale 40 can be adjusted for a different number of modules used in the elongation calculation and -or belt pitch. The elongation scale obviates the need to count the number of modules between the measurement starting mark and the elongation scale, as the elongation scale 40 is sized and configured so that the structural feature 52k of a predetermined module falls within the scale's range.

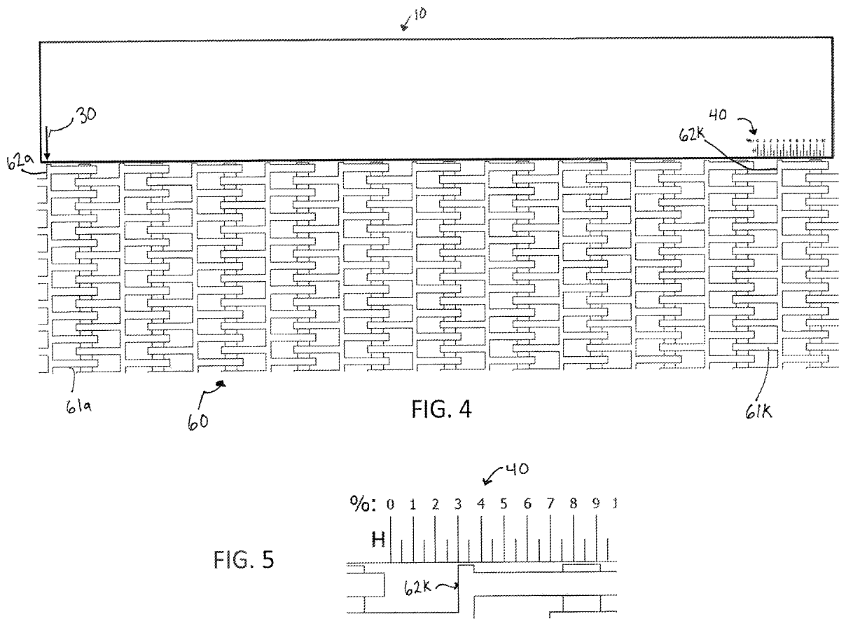

FIGS. 4 and 5 show the measuring device 10 used to measure an elongated conveyor belt 60 of the same belt pitch as the conveyor belt 50 of FIG. 3. As shown, a first structural feature 62a of a first module 61a of the conveyor belt 60 is aligned with the measurement starting mark 30. Then, a user determines the position of the same structural feature 62k in a subsequent module 61k. In the embodiment of FIGS. 4 and 5, the conveyor belt 60 has 3% elongation, as shown but the structural feature 62k aligning with the “3” mark in the elongation scale 40, showing a 3% elongation of the conveyor belt, which may indicate that the operator may wish to replace the conveyor belt. Described above, a non-structural, but measurable and repeated feature may alternatively be used to measure elongation.

Other suitable means for measuring elongation include, but are not limited to, a color scheme, text and other symbols. For example, an elongation scale can comprise a set of colors in a selected region in addition to or in lieu of the marks 41. For example, a belt elongation between 0% and 2% can be represented by a green color, a belt elongation between 2% and 3% can be represented by a yellow color to warn the user and a belt elongation over 3% can be represented by a red color to warn the user that the conveyor belt must be replaced. Symbols, such as check marks indicative of little elongation, exclamation points in a warning zone and “x” marks indicative of excessive elongation, can also be used.

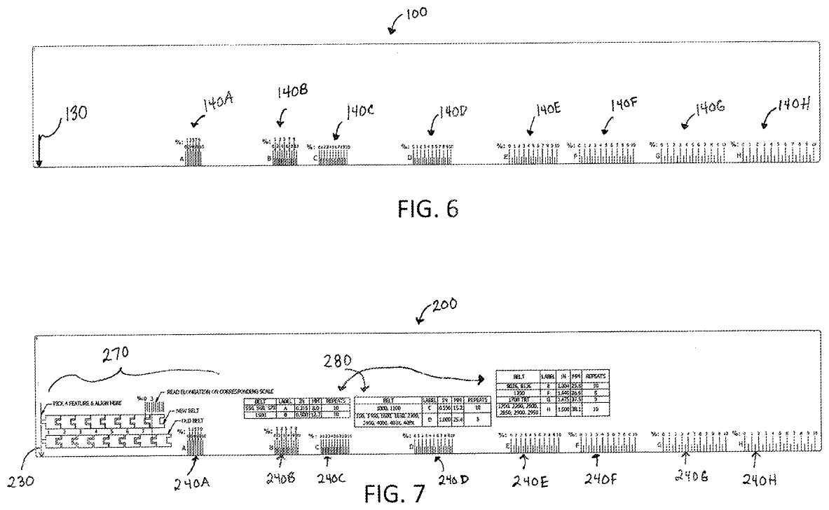

In an embodiment, a measuring device for determining conveyor belt elongation can include multiple elongation scales, each corresponding to a particular belt pitch. For example, as shown in FIG. 6, a conveyor belt elongation measuring device 100 may comprise a plurality of elongation scales 140A-140H, each corresponding to a particular belt pitch. Each elongation scale 140 is spaced from a measurement starting mark 130 by a selected distance such that the start of the elongation scale 140 (the 0% mark) equals the associated belt pitch times a selected number of modules. The number of modules may be varied to optimally place each elongation scale 140 relative to the measurement starting mark 130.

In addition to a plurality of elongation scales, a measuring device 200 for determining conveyor belt elongation can include imprinted instructions 270 for using the measuring device to determine elongation, as shown in FIG. 7. The instructions 270 instruct a user to align a feature of the conveyor belt with the measurement starting mark 230 and read the percent elongation on the elongation scale 240 corresponding to that particular conveyor belt. The illustrative measuring device 200 also includes a key 280 explaining the parameters for each elongation scale 240A-240H. The illustrative key 280 corresponds each elongation scale in the column “LABEL” with a particular type of belt (shown as a belt series) and lists the corresponding belt pitch in both inches and millimeters. In addition, the illustrative key 280 lists the number of modules to be measured between the measurement starting mark 230 and the particular elongation scale 240. The key 280 can have any suitable size, shape, format and configuration to facilitate use of the measuring device 200.

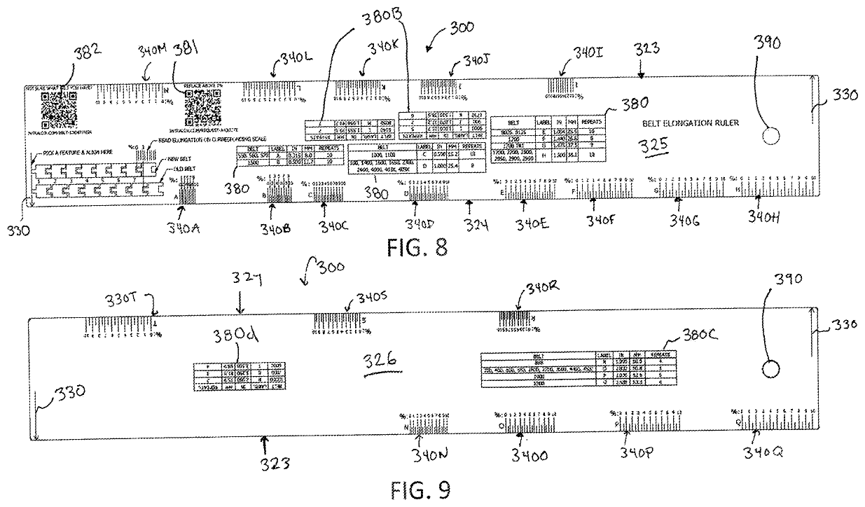

A conveyor belt elongation measuring device may be tailored for any suitable number and combination of conveyor belts. Referring to FIGS. 8 and 9, in one embodiment, a measuring device 300 for determining conveyor belt elongation can include elongation scales 340 and measurement starting marks 330 on both a top edge 323 and bottom edge 324 of a base and—or on both a first face 325 and an opposing second face 326. Keys 380 for the elongation scales 340A-340H on the bottom edge 324 face the bottom edge 324, while keys 380B for the elongation scales 3401-340M face the top edge 323.

The illustrative measuring device 300 further includes machine-readable symbols 381, 382 that a user may scan to order a replacement conveyor belt when the belt becomes too elongated and—or find additional information from the supplier of the conveyor belt. The illustrative machine-readable symbols are QR codes, but any form of unique machine-readable symbol or code may be used.

The second face 326, shown in FIG. 9, can include elongation scales 340N-Q on the edge 323, along with a key 380c, and elongation scales 340R-T on edge 324, along with a corresponding key 380d facing the edge 324.

The different elongation scales can be strategically placed so that elongation scales for even close or similar belt pitches do not overlap and are easy to read. Elongation scales for similar belt pitches can be placed on different edges and—or rely on a different number of modules between a measurement starting mark and the beginning of the elongation scale to facilitate use of the elongation measuring device.

The illustrative measuring device 300 further includes an opening 390 through the base for hanging the measuring device, attaching the measuring device to a wrist loop or lanyard or for another suitable purpose. Other suitable attachment mechanisms may be used.

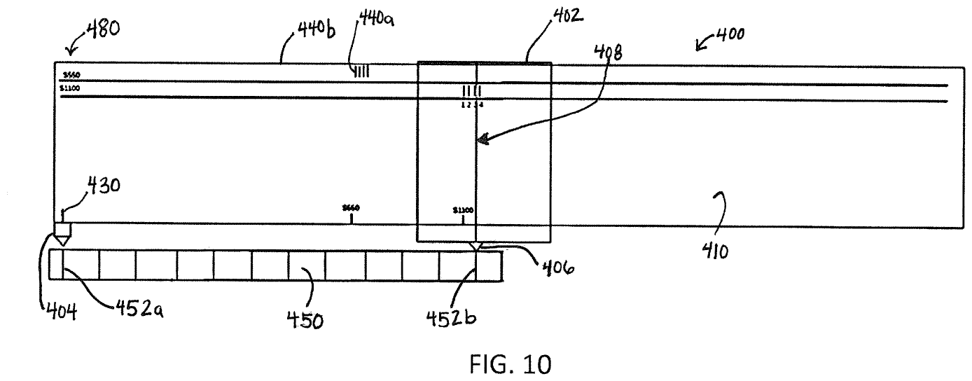

Referring to FIG. 10, in another embodiment, a measuring device 400 includes a sliding component 402 to facilitate measurement. The sliding component 402 can slide laterally over the base 410 of the measuring device 400. The illustrative measuring device 400 includes an alignment feature 404, shown as a protrusion extending below the bottom edge of the device having a tip aligned with a measurement starting mark 430. Another alignment feature 406 extends from the bottom of the sliding component 402. Elongation scales 440a, 440b, each corresponding to a particular conveyor belt, are displayed on the base. The sliding component 402 is clear or includes a sufficiently clear portion to allow the elongation scales 440 to show through when the sliding component overlaps them. A key 480 corresponds each elongation scale 440a, 440b with a particular pitch or type of conveyor belt. The illustrative sliding component 402 further includes a line 408 extending from and aligned with the alignment feature 406. To measure belt elongation, the measurement device 400 is placed next to a conveyor belt 450 with repeatable, measurable features. The first alignment feature 404 is aligned with a feature 452a. Then, the second alignment feature 406 is brought into alignment with a second measurable feature 452b on the conveyor belt within the range of the elongation scale 440a associated with the conveyor belt 450. The user then reads where the line 408 falls on the elongation scale 440a, which in the illustrative embodiment, shows an elongation of over 3%. The illustrative line 408 enables readout of smaller marks and enable stacking of multiple elongation scales.

While the illustrative markings are black, the invention is not so limited. For example, the markings can be in color, or, in the case of a dark-colored base, white or transparent. In another embodiment, the markings can glow in the dark to facilitate reading of the markings. In the case of etching, the markings can be the same color as the base and comprise structural features. Any suitable pre-measured markings may be used sufficient for indicating an amount of elongation for a conveyor belt. The markings can be formed by cutting slots in a base material, then laminating or otherwise sealing the measuring device while allowing the slots to show through. In addition, or alternatively, a light or lighting effect can be incorporated into the measuring device to facilitate reading of the measurements.

In addition, the measuring device can be digital, with the base including an LCD, OLED or LED screen or showing the measuring starting mark and one or more elongation scales. The markings could be displayed on a webpage or app on a phone, tablet, laptop screen or other electronic device. Another version could comprise an electronic paper display using electronic ink to form markings for measuring conveyor belt elongation.

The measuring device can be used with any conveyor belt that stretches and—or wears and has repetitive features, such as drive teeth, hinge rods, flights, and so on. Examples include, but are not limited to, modular conveyor belts, positive drive conveyor thermoplastic conveyor belts, such as ThermoDrive® belting, available from Intralox, L.L.C. of Harahan, LA, and others known in the art, as well as synchronous or timing belts and roller chains.

In addition, while the illustrative base is planar, in another embodiment, the base is three-dimensional and has three or more faces on which markings used to determine belt elongation are formed.

The invention is not limited to the illustrative measuring devices, and encompasses variations and alterations of these embodiments.

What is claimed is:

1. A device for measuring elongation of a conveyor belt, comprising:
a base;
a measurement starting mark on the base; and
an elongation scale spaced from the measurement starting mark, the elongation scale comprising a sequence of marks on the base, each mark corresponding to a percentage of belt elongation for a first belt pitch.

2. The device of claim 1, wherein the base is planar and comprises a first side edge, a second side edge, a top edge, a bottom edge, a first face and an opposite second face.

3. The device of claim 2, wherein the measurement starting mark is inset from the first side edge on the first face.

4. The device of claim 2, wherein the measurement starting mark comprises an arrow intersecting the bottom edge on the first face.

5. The device of claim 2, wherein the elongation scale is formed on the bottom edge of the first face.

6. The device of claim 1, wherein the sequence of marks comprises a first mark separated from the measurement starting mark by a distance equal to the first belt pitch multiplied by a whole number.

7. The device of claim 1, wherein the elongation scale includes colors corresponding to a condition of the conveyor belt.

8. The device of claim 1, further comprising a key on the base providing information to the user regarding the elongation scale.

9. The device of claim 1, further comprising instructions on the base for using the device.

10. The device of claim 1, further comprising a sliding component including alignment features mounted on and slidable relative to the base.

11. The device of claim 1, further comprising a second elongation scale spaced from the measurement starting mark, the second elongation scale corresponding to a second belt pitch.

12. A device for measuring elongation of a conveyor belt, comprising:
a base;
a measurement starting mark on the base;
a first elongation measurement region spaced from the measurement starting mark by a first distance, the first elongation measurement region corresponding to a first belt pitch, wherein the first distance is a multiple of the first belt pitch; and
a second elongation measurement region spaced from the measurement starting mark by a second distance, the second elongation measurement region corresponding to a second belt pitch, wherein the second distance is a multiple of the second belt pitch.

13. The device of claim 12, wherein the first elongation measurement region comprises a sequence of marks, each mark indicative of a percentage of belt elongation for the first belt pitch.

14. The device of claim 12, wherein the first elongation measurement region comprises an array of colors indicative of belt condition for a conveyor belt having the first belt pitch.

15. The device of claim 12, wherein the first elongation measurement region comprises a series of symbols indicative of belt condition for a conveyor belt having the first belt pitch.

16. A method of measuring conveyor belt elongation in a conveyor belt comprising a plurality of connected conveyor belt modules, comprising the steps of:
aligning a first structural feature of a first conveyor belt module with a measurement starting mark on a base of a measuring device;
aligning a second conveyor belt module with an elongation scale on the base of the measuring device; and
determining a position of a first structural feature of the second conveyor belt module along the elongation scale on the measuring device.

17. The method of claim 16, wherein the step of determining comprises reading a percentage elongation of the conveyor belt based on the elongation scale.

18. The method of claim 16, further comprising the step of, prior to the steps of aligning, identifying the elongation scale using a key on the base of the measuring device.

19. The method of claim 16, further comprising the step of replacing the conveyor belt if the elongation scale indicates that the conveyor belt is more than a particular percentage elongated.
